(19) United States
(12) Patent Application Publication
(10) Pub. No.: US 2024/0186650 A1
(43) Pub. Date: Jun. 6, 2024

(54) DEGASSING UNIT AND BATTERY HOUSING

(71) Applicant: MANN+HUMMEL GmbH, Ludwigsburg (DE)

(72) Inventors: Martin PLOPPA, Stuttgart (DE); Jorge RODRIGO, Zaragoza (ES); Jaime GRACIA, Zaragoza (ES)

(21) Appl. No.: 18/442,030

(22) Filed: Feb. 14, 2024

Related U.S. Application Data
(63) Continuation of application No. PCT/EP2022/070983, filed on Jul. 26, 2022.

(30) Foreign Application Priority Data
Sep. 6, 2021 (DE) 102021123031.4

(51) Int. Cl. H01M 50/30; H01M 50/342

(52) U.S. Cl. CPC H01M 50/394; H01M 50/3425

(57) ABSTRACT

A degassing unit for a battery housing is connectable fluid-tightly to a rim of a pressure compensation opening of the battery housing. The degassing unit has a main body provided with a gas passage opening and a fastening region for attachment of the degassing unit at the battery housing. A membrane covers the gas passage opening. A fluid-permeable membrane support device spans the membrane at an inner side of the membrane. A membrane carrier separate from the main body is connected by a reversibly detachable fastening device to the main body such that a movement of membrane carrier and main body relative to each other is blocked at least axially. The membrane carrier is sealed around the gas passage opening circumferentially fluid-tightly relative to the main body. The membrane is fastened by material fusion to the membrane carrier. A battery housing with such a degassing unit is provided.

### CROSS-REFERENCE TO RELATED APPLICATIONS

This application is a continuation application of International Application No. PCT/EP2022/070983 filed on Jul. 26, 2022, which claims the benefit of German Application No. 102021123031.4 filed on Sep. 6, 2021, the entire disclosures of which are incorporated herein by reference for all purposes.

### BACKGROUND

The invention concerns a degassing unit and a battery housing, in particular of a traction battery of a motor vehicle.

Housings for receiving electronic components such as, for example, battery cells and the like cannot be completely gas-tightly closed relative to the environment because, due to temperature fluctuations (for example, by heat introduction by charging or discharging of battery cells), on the one hand, and due to naturally occurring air pressure fluctuations, in particular in mobile systems, on the other hand, a gas exchange between interior and exterior must be enabled in order to prevent impermissible mechanical loads of the housing, in particular a bursting or bulging of the housing. However, it is likewise important that the ingress of foreign bodies, dirt, and moisture in the form of liquid water is prevented effectively.

Therefore, pressure compensation devices are known which comprise membranes which are in particular gas-permeable but liquid-impermeable.

When inside of the housing a pressure peak is generated, for example, due to failure of a battery cell in a battery housing, this pressure must be relieved as quickly as possible because otherwise the housing might become damaged.

As a simplest embodiment of a burst protection, for example, in case of lead batteries, it is known to use burst disks, in particular of a metallic sheet material, in the sense of a Arated break point@ or safety flaps or valves which are inserted into a housing opening.

On the other hand, highly specific pressure compensation devices which are optimized for fulfilling the aforementioned objects are used in case of high-voltage batteries, in particular lithium-based traction batteries with significantly higher storage capacities and power densities.

DE 10 2012 022 346 B4 discloses a degassing unit for a battery housing which comprises a main body which comprises a gas passage opening which is covered by a semipermeable membrane which is permeable for gases but impermeable for liquids, wherein the membrane is connected, in particular welded, stationarily and fluid-tightly to the main body. The main body is fluid-tightly connectable to a pressure compensation opening of the battery housing. In normal operation, the membrane ensures a gas exchange by means of its semipermeable properties while, for realizing an emergency degassing function, an emergency degassing spike facing the membrane is arranged at a cover body, perforates the membrane upon surpassing a stretching limit induced by a housing inner pressure, and causes it to rupture so that a sudden pressure compensation from the interior to the environment is possible. At an inner side which is facing the battery housing in a mounted state, an inner guard grid is connected to the main body, which is designed to prevent an ingress of foreign bodies into the battery housing and which supports the membrane against water pressure from the exterior. The inner guard grid is connected by hot stamp connections to the main body, which is preferably comprised of plastic material, and comprises passage openings for screwing the main body to the battery housing, wherein the main body comprises threads formed by metallic thread inserts for engagement of the screws used for screwing.

In the degassing units which are known from the prior art, the membrane in general is welded directly to the main body or is directly connected to the latter in other ways. This is disadvantageous because the main body, due to mandatorily required free passages for welding tools (sonotrodes) and/or testing tools, must be dimensioned to be very large. A direct welding of the membrane to the main body is furthermore inflexible because different technical specifications (for example, with respect to nominal or maximal volume flow, burst pressure etc.) placed on the degassing unit can be realized only by different main body types in this context.

Furthermore, degassing units are known in which the membrane, prior to its mounting at the main body, is preassembled together with a mounting frame to a construction unit in order to facilitate, on the one hand, the welding process and, on the other hand, improve handling of the typically thin membrane. Such a degassing unit is disclosed, for example, in DE 10 2020 129 933 A.

### SUMMARY

It is an object of the present invention to provide a degassing unit for a battery housing, in particular for a traction battery of a motor vehicle, which is characterized in that a membrane which is employed for realizing the pressure compensation function can be exchanged in-situ and can be adapted in a modular way to different technical specifications.

This object is solved by a degassing unit for a battery housing, in particular of a traction battery of a motor vehicle, connectable fluid-tightly to a rim of a pressure compensation opening of the battery housing, with a main body which comprises at least one fastening means action region configured for attachment of the degassing unit to the battery housing and which comprises a gas passage opening, wherein the gas passage opening is covered by a membrane which is spanned across at the side of its inner surface by at least one fluid-permeable membrane support device, wherein the degassing unit is characterized in that the membrane is fastened by material fusion to a membrane carrier which is separate from the main body and which is sealed around the gas passage opening circumferentially fluid-tightly in relation to the main body and connected to the main body such that a relative mobility of membrane carrier and main body is blocked at least in axial direction, wherein the membrane carrier is connected by a reversibly detachable fastening device to the main body.

This object is solved by a battery housing, in particular of a traction battery of a motor vehicle, comprising at least one housing wall with a pressure compensation opening, wherein battery cells can be arranged in the battery housing, wherein the pressure compensation opening is closed by a degassing unit, wherein the battery housing is characterized in that the degassing unit is a degassing unit according to the present invention.

Preferred further embodiments of the invention are disclosed in the dependent claims.

Advantages of the invention result from the description and the drawings. Likewise, the aforementioned and still to be disclosed features can be used in accordance with the invention individually by themselves or several thereof in any combinations. The illustrated and described embodiments are not to be understood as a complete list but have instead exemplary character for describing the invention.

According to the present patent application, the term degassing unit was selected for the device according to the invention. However, it is, of course, understood that the device according to the invention likewise can enable a venting action of an interior of the battery housing through the (porous) membrane and therefore the device according to the invention can also be referred to as Apressure compensation unit@ or Aventing unit@ in embodiments.

The herein used relative terms @inner@ and Aouter@ relate to a mounted state in relation to the battery housing, wherein Ainner@ means facing the battery housing and Aouter@ means facing the environment.

The degassing unit according to the invention for a battery housing, in particular for a traction battery of a motor vehicle, is connectable fluid-tightly to a rim of a pressure compensation opening of the battery housing. It comprises a main body which comprises at least one fastening means action region configured for attachment of the degassing unit to the battery housing and which has a gas passage opening. The gas passage opening is covered by a membrane which is engaged across at the side of its inner surface by at least one fluid-permeable membrane support device. The membrane is connected by material fusion to a membrane carrier which is separate from the main body, which is sealed around the gas passage opening circumferentially fluid-tightly in relation to the main body and is connected to the main body such that a relative mobility of membrane carrier and main body is prevented at least in axial direction. The membrane carrier is connected to the main body by a reversibly detachable fastening device.

Expressed in other words, the membrane carrier is fixed at least in axial direction in relation to the main body and, in the mounted state of the membrane carrier at the main body, explicitly cannot be lifted from the latter but is connected to the latter without a degree of freedom of movement in axial direction.

The connection of the membrane carrier to the main body is a reversibly detachable connection which means that the connection is not only detachable but furthermore can be detached without causing destruction. This has the technical effect that the membrane carrier, in case of a defect of the membrane, can be quickly and simply exchanged in the installed state of the degassing unit at the battery housing.

In embodiments, the reversibly detachable fastening device can be a bayonet connection, a snap connection or any other holding element. A bayonet connection comprises in this context the particular technical advantage that through it, by operating principle, very high contact forces can be generated so that the seal pretension forces required for sealing the membrane carrier in relation to the main body are producible without problem through it.

In embodiments, the membrane carrier can be rotatable relative to the main body in order to transfer the reversibly detachable fastening device embodied as bayonet connection from a blocked state into a released state, and vice versa. A blocked state is to be understood herein as the state of the bayonet connection which corresponds to the operating state of the degassing unit which means that in the blocked state the membrane carrier is secured at least in axial direction in relation to the main body in order to seal the gas passage opening circumferentially fluid-tightly in relation to the main body. The released state, on the other hand, is the state of the bayonet connection in which the reversibly detachable connection of the membrane carrier to the main body is canceled and the membrane carrier can be separated from the main body. For demounting the membrane carrier, the bayonet connection is therefore to be transferred from its blocked state into its released state while the bayonet connection is to be transferred from its released state into its blocked state for mounting the membrane carrier.

The bayonet connection is in particular embodied as a combined rotation/insertion connection which means that the movement course upon mounting/demounting comprises a first phase with an axial movement component as well as a second phase with a rotatory movement component, wherein the blocked state is reached finally by rotation.

Particularly advantageously, the membrane carrier can comprise at its outer side a tool engagement region which is configured for introducing a torque. The tool engagement region can comprise, for example, a hexagon socket/head, a triple square or a hexalobe socket and/or head. The invention is however expressly not limited thereto so that a tool engagement region can be understood herein as further structures which appear suitable to a person of skill in the art for introducing a torque. The tool engagement region is in particular arranged coaxial to a central longitudinal axis of the membrane carrier. By means of the tool engagement region, the required torques for mounting/demounting the membrane carrier can be introduced simply and without problem so that an exchange of the membrane carrier can be further accelerated in this way.

According to a further embodiment, first bayonet connection means can be formed at the main body and second bayonet connection means at the membrane carrier, which together form the bayonet connection. The first and/or second bayonet connection means each can comprise a securing wall extending in circumferential direction and extending substantially in a plane extending parallel to the membrane. By rotating the membrane carrier into the blocked state, it is achieved that the securing walls of the first bayonet connection means plunge axially behind the securing walls of the second bayonet connection means so that a form-fit blocking of an axial degree of freedom of movement of the membrane carrier in relation to the main body can be achieved.

In particular, the first and/or second bayonet connection means can comprise a rotation angle stop which determines an intended rotation angle end position of the membrane carrier. A rotation angle stop can be formed in particular on at least one of the first and/or second bayonet connection means, in particular in the form of a stop wall which adjoins a securing wall of the at least one bayonet connection means. In embodiments, at least one bayonet connection means correlated with the membrane carrier can comprise the rotation angle stop.

In embodiments, two, three, four or even more first and/or second bayonet connection means can be present, distributed about the circumference.

In a still further embodiment, the first and/or second bayonet connection means can comprise at least one ramp section extending in circumferential direction which is embodied in particular for converting a relative rotation movement of the membrane carrier in relation to the main body into an axially oriented contact force. In this way, the ramp section, by rotation of the membrane carrier, enables pretensioning a seal, acting in particular axially, between membrane carrier and main body in axial direction in order to achieve an optimal sealing action and prevent thereby bypass flows circumventing the membrane.

The fastening of the membrane in accordance with the invention at a membrane carrier separate from the main body is advantageous, on the one hand, during manufacture of the degassing unit because the connection, in particular welding, of the membrane to the membrane carrier can be realized with a significantly reduced apparatus expenditure compared to a direct welding in the main body. Also, downstream testing processes at the welded membrane are simplified because the latter is very easily accessible at the membrane carrier.

Furthermore, generating variants of the degassing unit according to the invention is advantageously enabled simply by the use of different membrane carrier/membrane combinations which can be inserted into the respective same main body. In this way, the membrane carrier/membrane combinations can differ, for example, in the cross section of its gas passage region, in the membrane type (fluid-permeable or fluid-impermeable), in the membrane properties (burst behavior), in the configuration of the membrane support device and in other features.

The modular construction of the degassing unit provided in accordance with the invention makes it therefore particularly easy to adapt the degassing unit to technical boundary conditions and generates the potential to even be able to produce small series in an inexpensive way because the most expensive device component (the main body) according to experience is a carry-over part for all variants.

The main body and/or the membrane carrier can be comprised substantially of plastic material, in particular thermoplastic plastic material, and in particular can be injection-molded. Preferred materials are polypropylene, polybutylene terephthalate or polyamide, each comprising reinforcement fibers, in particular glass fibers.

The membrane support device supports the membrane against external pressure actions (e.g., against water pressure in case of driving through water and/or use of cleaning devices in vehicles) and prevents impermissible deformations of the membrane. Furthermore, by means of the membrane support device, a protective function for ensuring an ingress protection in relation to the battery housing (corresponding to IP classification) is achieved.

A distance by which the membrane support device is spaced from the inner membrane surface can lie between 0.1 mm and 1.0 mm, preferably between 0.5 mm and 0.8 mm. The distance can however also be Azero@ so that the membrane contacts the membrane support device already in the rest state.

The fluid-permeable membrane support device can be configured as a grid section with a plurality of grid webs and grid openings positioned therebetween. The grid webs can be arranged in a rectangular pattern or as a combination of circumferentially and radially extending grid webs. Alternatively, the grid webs can be present in the form of other polygonal patterns, for example, in the form of pentagons or hexagons.

The membrane support device can comprise or be comprised of a metal. Alternatively, the membrane support device can comprise or be comprised of a plastic material, preferably polypropylene and/or polybutylene terephthalate, each preferably comprising reinforcement fibers, in particular glass fibers. Preferably, the membrane support device is however comprised of the same material as the main body and/or the membrane carrier.

The membrane can be, on the one hand, a semipermeable membrane which enables passage of gaseous media from an environment into the battery housing, and vice versa, but prevents the passage of liquid media and/or solids.

On the other hand, the membrane can be a fluid-tight membrane, in particular a plastic film. As fluid-tight membrane, for example, non-porous films in the form of polymer films can be used. Laminated films, film compounds or also functionally furnished, in particular metallized, films can be used in order to ensure seal-tightness of the housing in intended operation. For example, polypropylene is suitable as a basic material for the polymer film. Different material pairs of main body and film are also conceivable when using suitable bonding techniques, in particular gluing.

All materials which comprise a proper high gas permeability for venting and a sufficiently high impermeability for liquid water can be used for the semipermeable membrane. The semipermeable membrane can in particular comprise or be comprised of a porous film. As preferred material for the semipermeable membrane, polytetrafluoroethylene (PTFE) can be used. The semipermeable membrane comprises an average pore size that lies between 0.01 micrometers and 20 micrometers. The porosity is preferably approximately 50%; the average pore size amounts to preferably approximately 10 micrometers.

The membrane can be preferably designed as a film-type or film-shaped or disk-shaped thin membrane. The membrane can comprise preferably a rectangular or a round outer contour at its outer circumference. It is understood however that the outer circumference of the membrane can also be designed differently. The membrane is preferably a thin flat membrane whose membrane surfaces facing away from each other are configured substantially parallel to each other and preferably substantially planar.

The membrane thickness of the membrane is much smaller than its other outer dimensions. The membrane can span across a minimum width and/or a minimum length or a minimum outer diameter of equal to or larger than 20 mm, preferably of equal to or larger than 30 mm, in particular of equal to or larger than 40 mm. The membrane thickness can be in particular at least 20 times, preferably at least 40 times, in particular at least 100 times, smaller than the minimum width and/or the minimum length or the minimum outer diameter of the membrane. The membrane thickness can amount to 1 micrometer to 5 millimeters, wherein a membrane thickness of 0.1 to 2 mm, in particular 0.15 to 0.5 mm, is preferred.

In a further embodiment, the membrane support device is formed at the membrane carrier, in particular monolithically with the membrane carrier. This increases the flexibility for providing variants of the degassing unit according to the invention even further because properties of the membrane support device can also be adapted individually and inexpensively.

In another also preferred further embodiment, the degassing unit can comprise an emergency degassing spike which extends at the outer side in axial direction toward the membrane and whose tip is present at a predetermined distance away from an outer membrane surface in a rest state.

The emergency degassing spike in the rest state (no differential pressure load) is arranged at a predetermined distance relative to the membrane surface. Under pressure load (relative excess inner pressure), the membrane will bulge in the direction to the exterior and upon reaching a limit pressure will contact the tip of the emergency degassing spike. Due to its tip, the emergency degassing spike then produces a targeted weakening of the membrane so that the latter ruptures. This serves for ensuring an emergency degassing function reacting as quickly as possible which is important in order to be able to ensure that the housing structure remains intact in case of a sudden inner pressure increase in the battery housing. By a variation of the distance of the tip of the emergency degassing spike from the membrane surface, the emergency degassing pressure can be adjusted.

The emergency degassing spike can be formed at the membrane carrier, in particular as one piece together with the membrane carrier. As an alternative, the degassing spike can also be formed at the main body, in particular as one piece together with the main body. The embodiment according to which the emergency degassing spike is formed at the membrane carrier, increases the flexibility for providing variants of the degassing unit according to the invention even further because properties of the emergency degassing action are also adaptable individually and inexpensively. In this way different degassing pressures can be realized, in particular in the modular component, without having to change properties of the main body.

In a further embodiment, the membrane carrier can comprise a fluid-permeable gas passage region and a membrane fastening region circumferentially surrounding the gas passage region. In the membrane fastening region, the membrane is connected circumferentially to the membrane carrier, in particular welded thereto. The membrane completely covers the gas passage region of the membrane carrier. Aside from welding of the membrane, also gluing is conceivable, for example, by means of a circumferentially applied adhesive strip.

In embodiments, the membrane carrier can have a round cross section, preferably circular cross section, or polygonal cross section, in particular rectangular cross section, in particular with rounded corners.

In embodiments, a cross section of the gas passage region of the membrane carrier can be different from a cross section of the gas passage opening of the main body, in particular can be smaller than the latter. It is accordingly possible that an effective gas passage cross section of the degassing unit is determined by the cross section of the gas passage region of the membrane carrier. In this way, it is made possible to generate, by means of differently sized membrane carriers by using the same main body, variants of the degassing unit according to the invention which differ, alternatively or additionally to the already mentioned features, in their effective gas passage cross section.

In a further embodiment, the membrane carrier can be sealed by a circumferentially extending seal element in relation to the main body. The circumferentially extending seal element can be in this context an O-ring seal or a seal lip, in particular a 2K seal lip. The seal element, in particular the O-ring seal, can be arranged at the membrane carrier, for example, in a seal groove of the membrane carrier. Alternatively, the seal element can also be present at the main body. The seal element can be effective axially and/or radially, wherein also combined seal elements are possible, i.e., effective axially as well as radially in portions.

The connection of membrane carrier and main body can be realized in particular such that the membrane carrier is connected to the main body from the inner side of the degassing unit. Preferably, the membrane carrier is arranged at the inner side of the main body.

However, in embodiments it is also possible that the membrane carrier is connected to the main body from the exterior of the degassing unit, wherein the membrane carrier is present in particular at the outer side of the main body. This is in particular possible in embodiments in which the emergency degassing spike is embodied as part of the membrane carrier. This embodiment has the technical advantage that the membrane carrier can be separated from the main body while the main body is mounted at the battery housing. In other words, the membrane carrier can be exchanged without problem while the main body is attached to the battery housing so that, in this way, an exchange of a defective membrane can be realized quickly and with minimal expenditure, in particular directly in the vehicle.

In embodiments, the degassing unit can comprise a housing seal which surrounds circumferentially the gas passage opening at the inner side of the degassing unit. In particular, the housing seal can be present at an inner side of the membrane carrier or at the inner side of the main body.

The housing seal can be embodied as an axial or radial seal, i.e., in particular at an end face (in case of an axial seal) or at a circumferential surface (in case of a radial seal) of a component of the degassing unit. The housing seal can be embodied as an O-ring which is received in a corresponding groove of a component of the degassing unit or as a molded-on seal component. An arrangement of the housing seal in axial configuration is preferred. The housing seal can be embodied in particular also as a shaped seal with a non-circular cross section, in particular elongate in longitudinal direction.

Furthermore, the membrane support device can also be embodied as a component separate from the membrane carrier and in particular can be arranged at the inner side of the main body. In particular, the membrane support device can be connected immediately to the main body at the inner side of the main body. In particular, the membrane support device in this context acts as any other holding element and holds the membrane carrier with form fit at the main body. For example, the membrane support device is attached in such a way to the main body that it clamps the membrane carrier at the main body.

In embodiments, the fastening means action region of the main body can comprise a bore, in particular a blind bore, which is open toward the inner side of the main body and/or the outer side of the main body. In particular, at least one reinforcement sleeve is provided in the bore. The reinforcement sleeve can furthermore preferably comprise also a thread section. The reinforcement sleeve can be comprised in particular of a material which is stiffer than the material of the main body, in particular of a metal, in particular of brass.

In yet another embodiment, the degassing unit can comprise a cover comprising preferably at least one venting opening. The cover is in particular connected at the outer side to the main body and/or to the membrane carrier. The connection of cover and main body or membrane carrier can be realized, for example, by a lock element engagement. The lock element engagement can be realized herein, for example, at the outer circumference of the main body or membrane carrier or, in a more general sense, at the end face at its outer side. For attachment of the cover also other fastening means are however conceivable, for example, form-fit or friction-fit fastening means, for example, screws or clips, or material fusion connections, in particular (ultrasonic and/or friction) welding. In embodiments, the emergency degassing spike can be formed at the cover.

A further aspect of the invention concerns a battery housing, in particular of a traction battery of a motor vehicle. The battery housing comprises at least a housing wall with a pressure compensation opening, wherein in the battery housing preferably battery cells can be arranged and wherein the pressure compensation opening is closed by a degassing unit according to the invention.

In particular, mounting of the degassing unit is provided in this context such that by means of at least one fastening means, in particular a screw, it is connected to a wall of the battery housing, wherein the fastening means is in engagement with the fastening means action region of the main body. Due to the screw connection, the seal pretension forces required for compression of the housing seal are generated. The screw connection can be realized in particular from an interior of the battery housing. Of course, also embodiments of the invention are encompassed in which the screw connection of the degassing unit to the battery housing is realized from the exterior.

Finally, the housing wall of the battery housing can comprise at an outer side a seal surface which circumferentially surrounds the pressure compensation opening and at which the housing seal of the degassing unit is resting in a mounted state. The seal surface is preferably embodied as a region of the wall of the battery housing with deviations as small as possible with respect to planeness and minimal roughness. Suitably, the battery housing or at least its wall comprises or is comprised of a metal material so that the seal surface with respect to the aforementioned properties can be obtained simply by mechanical machining.

### BRIEF DESCRIPTION OF DRAWINGS

Further advantages result from the following drawing description. In the drawings, embodiments of the invention are illustrated. The drawings, description, and claims contain numerous features in combination. A person of skill in the art will consider the features expediently also individually and combine them to expedient further combinations.

FIG. 1 shows an isometric view of a degassing unit according to the invention according to a first embodiment from the exterior.

FIG. 2 shows an isometric view of the degassing unit according to the invention according to the first embodiment from the interior.

FIG. 3 shows a longitudinal section view of the degassing unit according to the invention according to the first embodiment.

FIGS. 4A and 4B each show a respective isometric view of a membrane carrier of the degassing unit according to the invention according to the first embodiment.

FIG. 5 shows an isometric view of a main body of the degassing unit according to the invention according to the first embodiment from the interior without membrane carrier.

FIG. 6 shows an isometric view of a degassing unit according to the invention according to a second embodiment from the exterior.

FIG. 7 shows an isometric view of the degassing unit according to the invention according to the second embodiment from the interior.

FIG. 8 shows a longitudinal section view of the degassing unit according to the invention according to the second embodiment.

FIGS. 9A, 9B, and 9C each show a respective isometric view of a membrane carrier of the degassing unit according to the invention according to the second embodiment.

FIG. 10 shows an isometric view of a main body of the degassing unit according to the invention according to the second embodiment from the interior without membrane carrier.

FIG. 11 shows an isometric view of a degassing unit according to a third embodiment from the exterior.

FIG. 12 shows an isometric view of a degassing unit according to the third embodiment from the interior.

FIG. 13 shows an isometric view of a main body of the degassing unit, according to the third embodiment from the interior without membrane carrier.

FIG. 14 shows a longitudinal section view of the degassing unit according to the third embodiment.

FIGS. 15A, 15B, and 15C each show a respective isometric view of a membrane carrier of the degassing unit, according to the third embodiment.

FIG. 16 shows an isometric view of a degassing unit according to the invention according to a fourth embodiment from the interior.

FIG. 17 shows an isometric view of a main body of the degassing unit according to the invention according to the fourth embodiment from the interior with membrane carrier but without membrane support device.

FIG. 18 shows a longitudinal section view of the degassing unit according to the invention according to the fourth embodiment.

FIGS. 19A, 19B, and 19C each show a respective isometric view of a membrane carrier of the degassing unit according to the invention according to the fourth embodiment.

FIG. 20 shows an isometric view of a degassing unit according to the invention according to a fifth embodiment from the exterior.

FIG. 21 shows an isometric partial section view of the degassing unit according to the fifth embodiment.

FIG. 22 shows an isometric exploded view of the degassing unit according to the fifth embodiment.

FIG. 23 shows an isometric view of a degassing unit according to the invention according to the fifth embodiment from the interior.

FIG. 24 shows an isometric view of a membrane carrier of the degassing unit according to the fifth embodiment.

### DETAILED DESCRIPTION

In the Figures, same or same-type components are identified with same reference characters. The Figures show only examples and are not to be understood as limiting. Features or feature combinations which are disclosed in connection with a certain embodiment can be transferred also to the other embodiments, if not explicitly excluded.

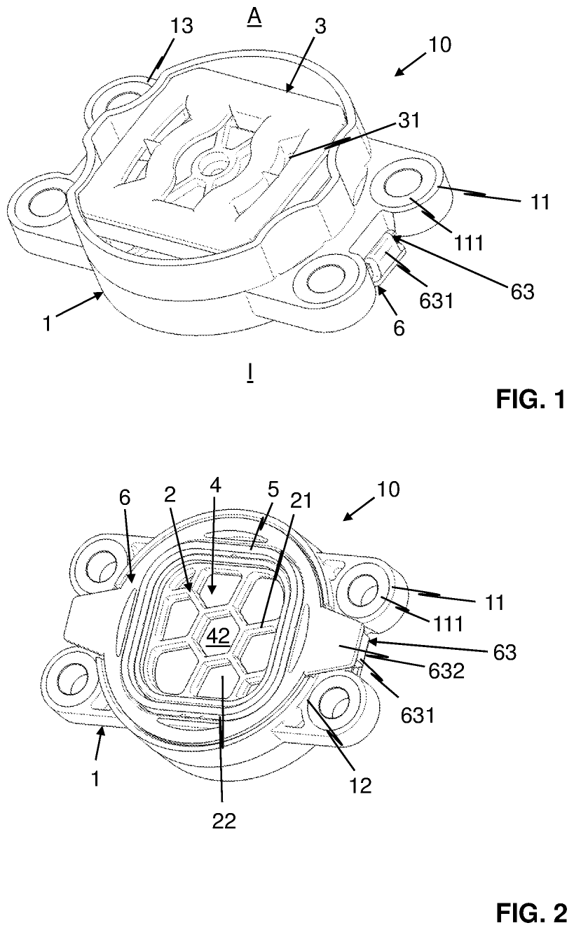

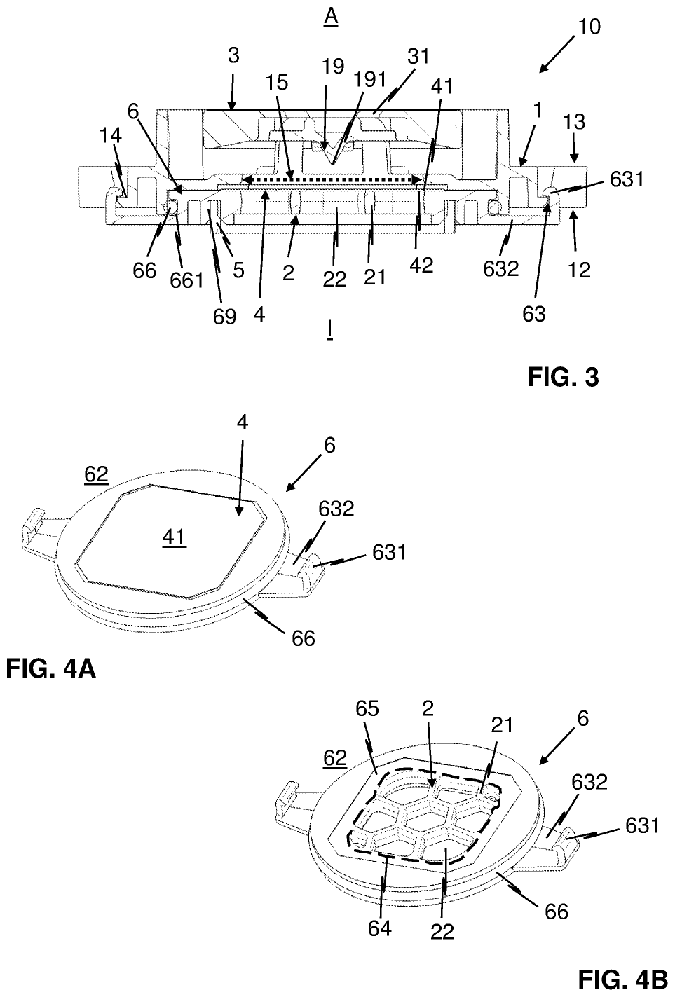

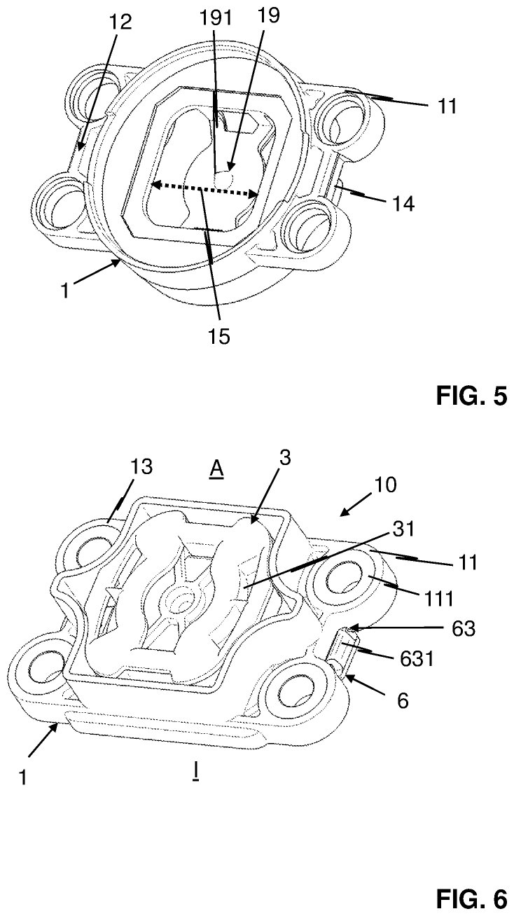

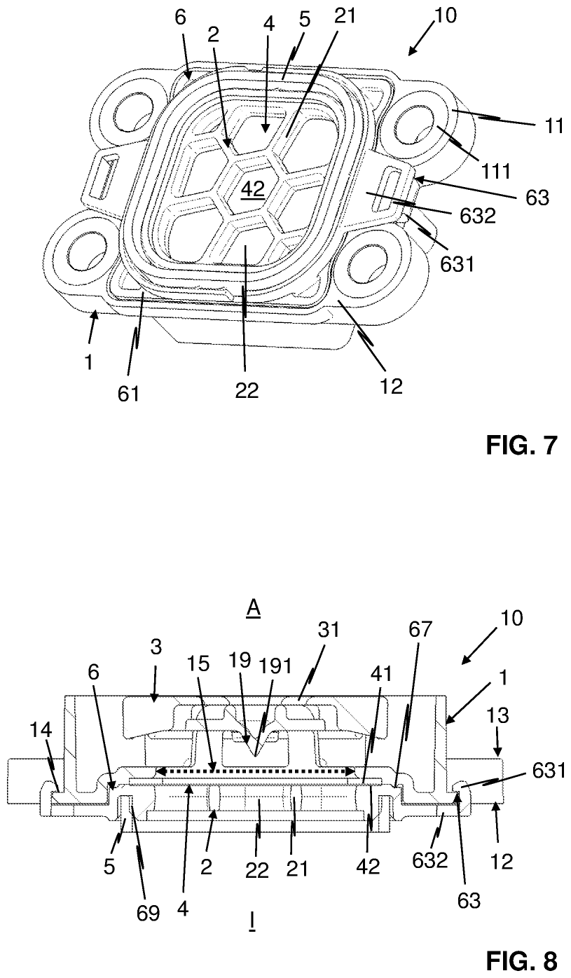

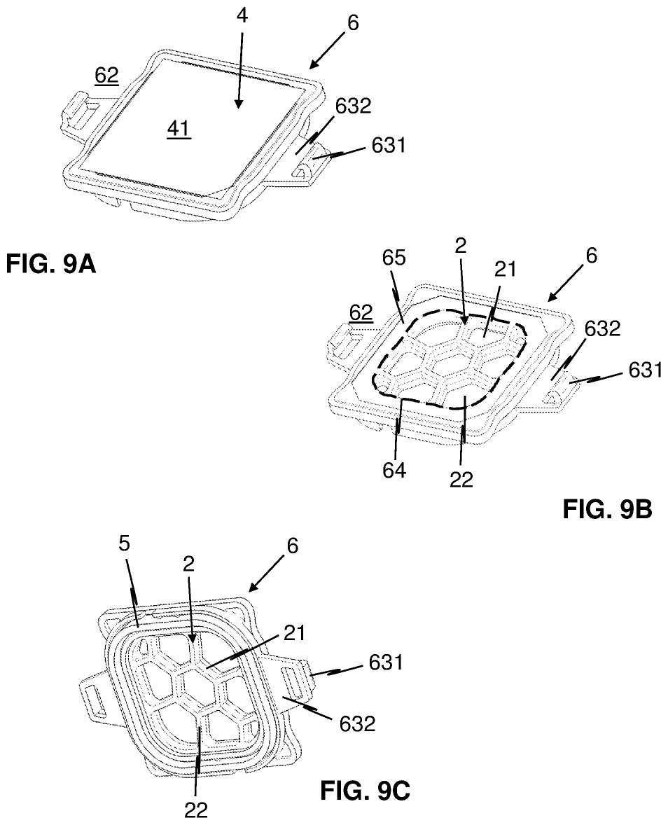

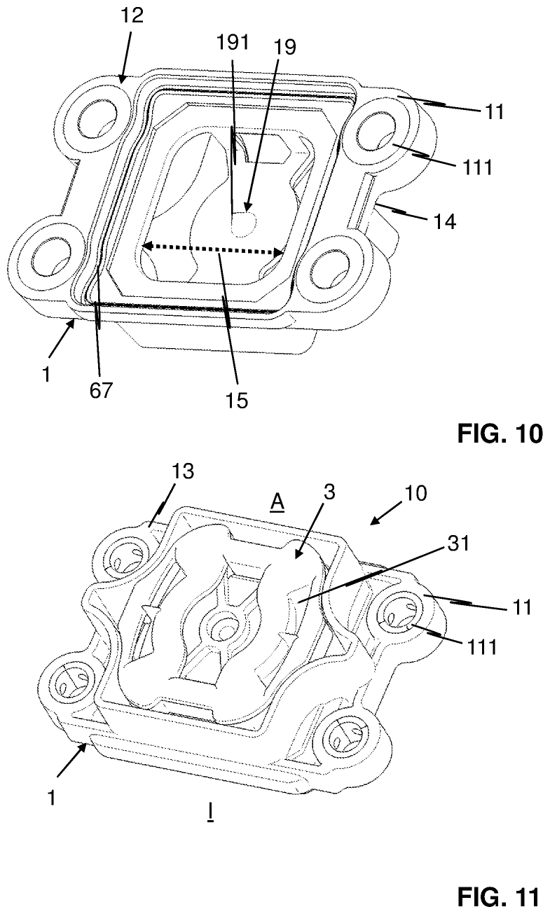

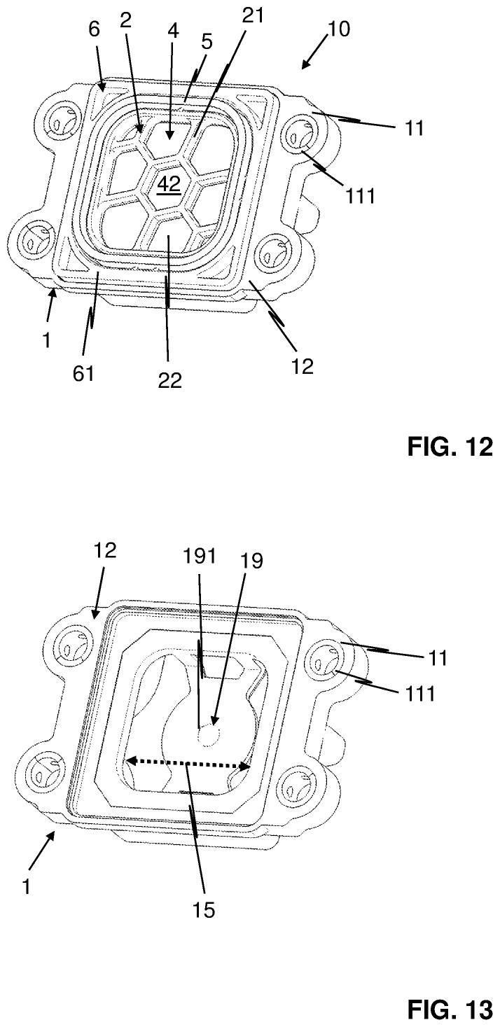

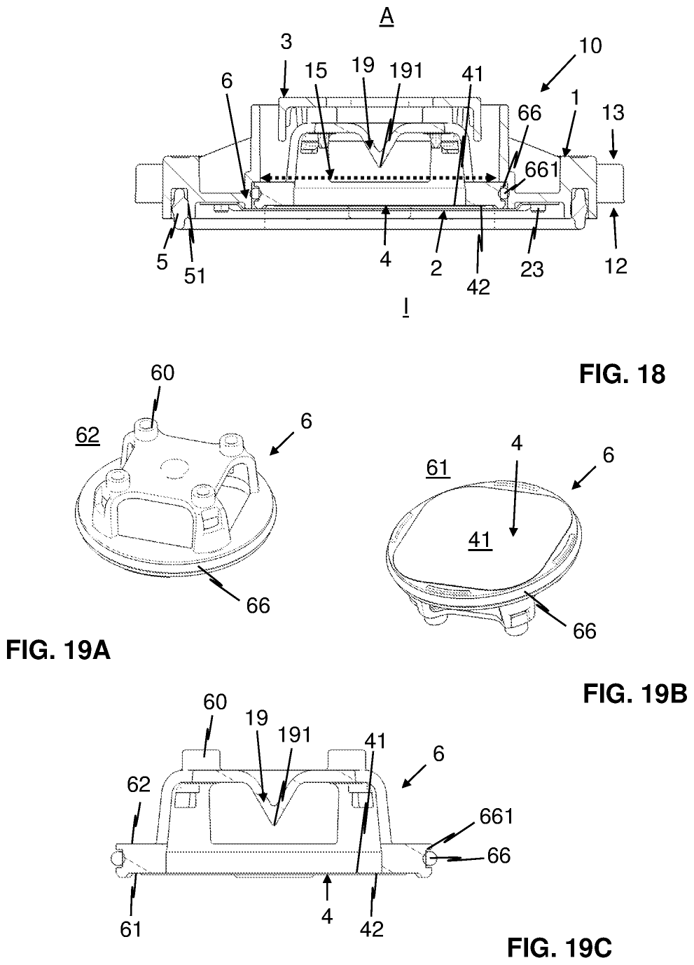

The degassing unit 10 according to the invention illustrated in FIG. 1 to FIG. 19 comprises a main body 1 which by means of a screw connection is connectable externally to a rim of a pressure compensation opening of a battery housing, in particular of a battery housing of a traction battery. For attachment of the degassing unit 10, the screws can be brought into engagement with the fastening means action regions 11 of the main body. In the fastening means action regions 11, respective reinforcement sleeves 111 are present which absorb the fastening forces in order to protect the main body 1 which is generally comprised of plastic material. The degassing unit 10 can be mounted externally to a battery housing and can be screw-connected from the interior. Alternatively, a screw connection from the exterior is also possible, wherein the screws are pushed through the fastening means action regions 11. For fluid-tight sealing of the degassing unit 10 at the wall of the battery housing, a housing seal 5 is provided which can be compressed by a seal pretensioning force.

The main body 1 has a gas passage opening 15 through which a pressure compensation between housing interior and the environment as well as in reverse can take place.

Furthermore, the degassing unit 10 comprises a membrane 4 which is permeable as a semipermeable membrane 4 for gaseous fluids but prevents passage of solids and liquids. Preferably, the membrane 4 is configured as a porous PTFE film. In embodiments, the membrane 4 can also be embodied as a fluid-impermeable membrane 4, for example, as plastic film. In this case, the degassing unit 10 does not fulfill the function of a venting action in normal operation but serves primarily for degassing in emergency (cell defect).

The membrane 4 is spanned at the inner side by a fluid-permeable membrane support device 2 which is present at a predetermined distance away from the membrane 4. The membrane support device 2 has a plurality of grid webs 21 between which a plurality of grid openings 22 are present.

At the outer side A of the degassing unit 10, a cover 3 is present which comprises at least one venting opening 31 and is configured to provide protection for the sensitive membrane 4 so that the latter cannot be damaged from the exterior either by foreign bodies, for example, pointed objects such as screwdrivers, or by means of high-pressure cleaners and/or steam cleaners. Construction and dimensioning of the cover 3 thus contribute substantially to a high IP protection class.

The degassing unit 10 according to the invention comprises furthermore an emergency degassing spike 19. The latter extends toward the membrane 4 and in the rest state (no differential pressure load) is arranged at a predetermined distance in relation to the outer membrane surface 41. Under pressure load (relative excess inner pressure), the membrane 4 will bulge in direction toward the exterior and, when reaching a limit pressure, will contact the tip 191 of the emergency degassing spike 19. Due to its tip 191, the emergency degassing spike 19 then produces a targeted weakening of the membrane 4 so that the latter ruptures. This serves for securing an emergency degassing function reacting as quickly as possible, which is important in order to be able to ensure that the housing structure remains intact in case of a sudden inner pressure increase in the battery housing. By a variation of the distance of the tip 191 of the emergency degassing spike 19 from the membrane surface 41, the emergency degassing pressure can be adjusted.

FIG. 1 to FIGS. 4A, 4B now show a degassing unit 10 according to the invention in a first embodiment.

The membrane 4 is held at a membrane carrier 6 which is separate from the main body 1 and is connected by a snap connection 63 to the main body 1 such that a movement of the main body 1 and of the membrane carrier 6 relative to each other is blocked. In other words, the membrane carrier 6 cannot be lifted off the main body 1 in the connected state. The membrane carrier 6 comprises snap hooks 631 which each engage with form fit behind an undercut section 14 at the main body. The snap hooks 63 are oriented radially inwardly and are each connected by a radially extending connection section 632 to a membrane carrier base. The snap hooks 631 engage the main body 1 at an outer circumference of the main body 1.

According to this embodiment, the connection of membrane carrier 6 and main body 1 can be detachable; this enables in particular an exchange of the membrane carrier 6 for a differently dimensioned membrane carrier at any time.

The membrane carrier 6 comprises the membrane 4 as well as the membrane support device 2 which is embodied monolithically with the membrane carrier 6, wherein the membrane carrier 6 preferably can be produced as an injection-molded part from a suitable plastic material. The membrane support device 2 comprises a grid structure with grid webs 21 which are embodied in the form of hexagons, wherein grid openings 22 are present between the grid webs 21. The membrane support device 2 spans the inner membrane surface 42 of the membrane 4.

The membrane 4 is connected to the membrane carrier 6, in particular welded or glued thereto. The connection of the membrane 4 to the membrane carrier 6 is realized in the membrane fastening region 65 (see FIGS. 4A, 4B) surrounding the gas passage region 64. In this context, the membrane 4 completely spans the gas passage region 64 in which the membrane support device 2 is present.

The membrane carrier 6 is connected from the inner side 12 of the main body 1 to the latter and arranged at the inner side 12 of the main body 1 so that the latter in a mounted state is present at a battery housing so as to face the battery housing. The main body outer side 13 is therefore facing away from the battery housing in this mounting state.

At the membrane carrier 6, a radially outwardly open seal groove 661 is formed in which a seal element 66 embodied as an O-ring is received. By means of the seal element 66, the membrane carrier 6 is fluid-tightly sealed, circumferentially around the fluid passage opening 15 of the main body 1, relative to the main body 1. The sealing contact between membrane carrier 6 and main body 1 is realized in an axially extending circumferential collar section of the main body 1 into which a corresponding counter section of the membrane carrier 6 is immersed axially. The seal element 66 seals radially in relation to a wall of the axially extending collar section of the main body 1.

Furthermore, the housing seal 5 is embodied at the membrane carrier 6 and is received in a housing seal groove 69 at the inner side 61 of the membrane carrier 6. The housing seal 5 is arranged at the membrane carrier inner side 61 such that it surrounds circumferentially the gas passage region 64. In the mounted state at a battery housing, the main body 1 is therefore sealed indirectly in relation to the battery housing.

The emergency degassing spike 19 is formed at the main body 1, in particular in the form of one-piece injection molded part.

The second embodiment of the degassing unit 10 illustrated in FIG. 6 to FIG. 10 differs from the first embodiment primarily in the type of sealing action of the membrane carrier 6 in relation to the main body 1.

The membrane carrier 6 is sealed in relation to the main body 1 by means of a seal lip 67 (see FIG. 8) provided at the main body 1. The seal lip 67 is in particular embodied as a 2K seal lip injection molded as one piece together with the main body. The sealing contact between membrane carrier 6 and main body 1 provides an axial sealing action by contact of the seal lip 67 of the main body 1 on the outer side 62 of the membrane carrier. The sealing contact is realized in a section of the membrane carrier 6 which is positioned radially outside of the gas passage region 64 in such a way that the seal line surrounds circumferentially completely the gas passage region 64 of the membrane carrier 6. In embodiments, which are not illustrated, an (axial) seal lip can be, of course, present also at the membrane carrier 6.

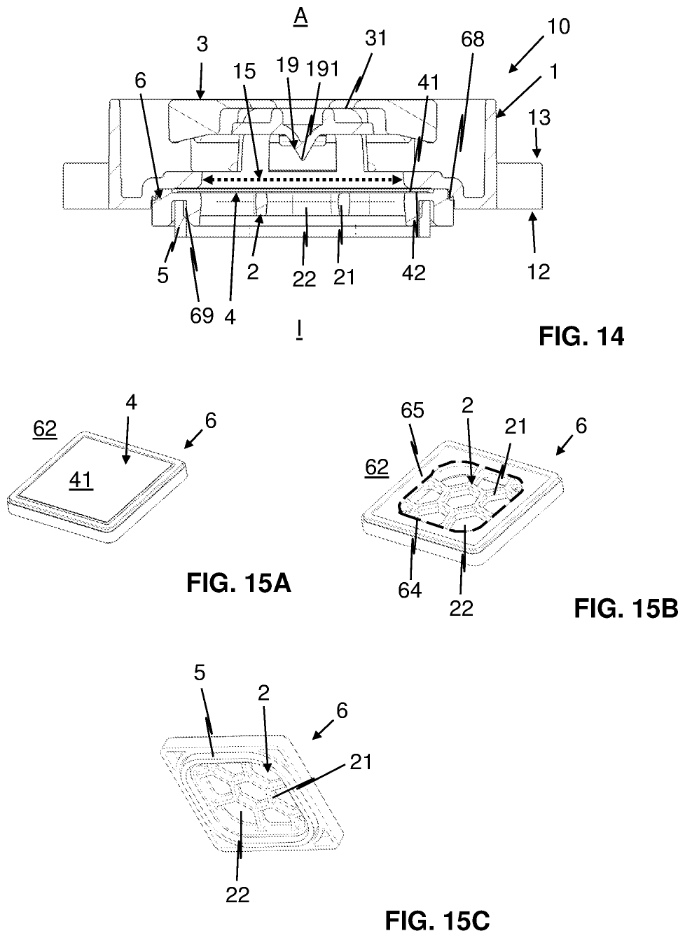

The third embodiment of the degassing unit 10 illustrated in FIG. 11 to FIGS. 15A-15C differs from the first and second embodiments in that the membrane carrier 6 is not connected with form fit by a snap connection at the main body 1 but by a weld connection 68. The membrane carrier 6 is therefore embodied as a simple plate comprising the gas passage region 64 and the membrane fastening region 65 and has no snap hooks. At the outer side 62 of the membrane carrier 6, a circumferential shoulder is present which is positioned radially spaced apart from the rim and provides an axially oriented weld surface. The connection to the inner side 12 of the main body 1 is realized now in the contact zone of this weld surface to the main body 1 (see FIG. 14). The welding action can be realized in particular by vibration welding or ultrasonic welding, wherein a corresponding weld tool can be applied without problem due to the easily accessible inner side 61 of the membrane carrier 6 in the assembled state.

The step which is formed circumferentially radially outside of the shoulder of the membrane carrier 6 can act as a material catching zone in order to retain weld flash.

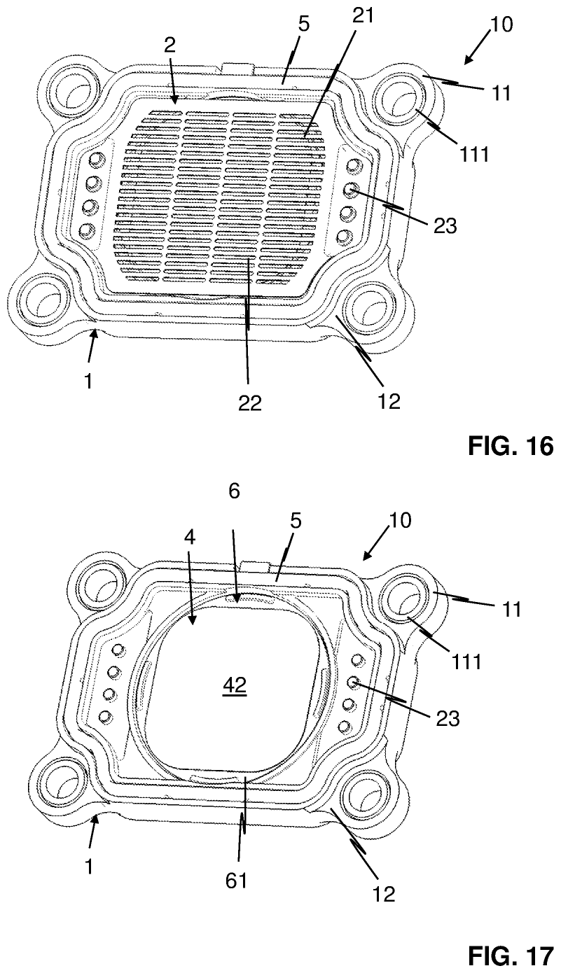

In FIG. 16 to FIG. 19, a fourth embodiment of the degassing unit 10 according to the invention is finally illustrated. It differs fundamentally from the other embodiments.

Even though the membrane 4 is also arranged at a membrane carrier 6 which is separate from the main body 1 and which is coupled from an inner side I of the degassing unit 10 to the main body 1, the membrane carrier 6 is however not embodied monolithically with the membrane support device 2 but monolithically with the emergency degassing spike 19. The membrane carrier 6 is inserted from an inner side 12 of the main body 1 into a circumferentially extending receiving region of the main body 1, wherein in the receiving region a radially projecting collar is present at which the membrane carrier 6 with its outer side 62 comes axially into contact.

At its inner side 61, the membrane carrier 6 is held by a contact at the membrane support device 2 which clamps it in the receiving region of the main body 1.

The membrane support device 2 is here embodied in particular as a metal component and is connected directly to the main body 1. The connection of the membrane support device 2 and the main body 1 is realized by rivet connections 23 which can be produced in the plastic material of the main body 1 particularly easily and reliably.

The sealing action of the membrane carrier 6 in relation to the main body 1 is realized in analogy to the first embodiment by a seal element 66 which is provided in a seal groove 661 at the outer circumference of the membrane carrier 6 and which seals radially in relation to a wall of the receiving region of the main body 1 in the assembled state.

The housing seal 5 is positioned according to the fourth embodiment of the degassing unit 10 directly at the main body 1. It is arranged in a circumferentially extending seal groove 51 at the inner side 12 of the main body 1 and surrounds the gas passage opening 15 completely circumferentially.

The cover 3 which provides at least one venting opening 31 is connected at the outer side 62 of the membrane carrier 6 to the membrane carrier 6, wherein the connection is realized by an engagement of lock elements 60, provided at the membrane carrier 6, at the cover.

The fourth embodiment expands the spectrum of the properties of the degassing unit, which can be influenced by the modular construction, by an adjustment of the emergency degassing behavior (shape and distance of the tip 191 of the emergency degassing spike 19 from the outer membrane surface 41).

All embodiments have in common the configuration of the membrane carrier 6 separate from the main body 1. This configuration simplifies the manufacture of the degassing unit 10 according to the invention significantly because welding of the membrane 4 is not realized directly in the main body 1 but in the separate membrane carrier 6. The welding process at the membrane carrier 6 is significantly less expensive and possible faster because it has no disturbing contours which might impair the engagement of the weld tools. Furthermore, there is the advantage that, due to the construction according to the invention, no free spaces for engagement of weld tools must be provided in the main body 1 so that the main body 1 additionally can be designed to be significantly smaller.

Due to the construction in accordance with the invention, process steps in the manufacture downstream of welding are also simplified however; in particular a leakage testing of the membrane weld can be realized for the separate arrangement of the membrane 4 at the membrane carrier 6 significantly more easily and faster than in the known arrangement of the membrane 4 directly at the main body 1.

Furthermore, the concept of the separate construction of membrane carrier 6 and main body 1 upon which the invention is based makes it possible to produce variants of the degassing unit 10 according to the invention with a very minimal expenditure due to the use of differently designed combinations of membrane carrier 6 and membrane 4, wherein the main body in all variants is a carry-over part. Due to an individual adaptation of the unit of membrane carrier 6 and membrane 4, the most important functional parameters of the degassing unit 10 can be adjusted, inter alia their degassing behavior (burst pressure), the effective passage cross section, type and mechanical properties of the membrane 4.

Due to the concept according to the invention, individual requirements in regard to the specifications of the degassing unit 10 can therefore be realized in a targeted fashion and realized with minimal lead time.

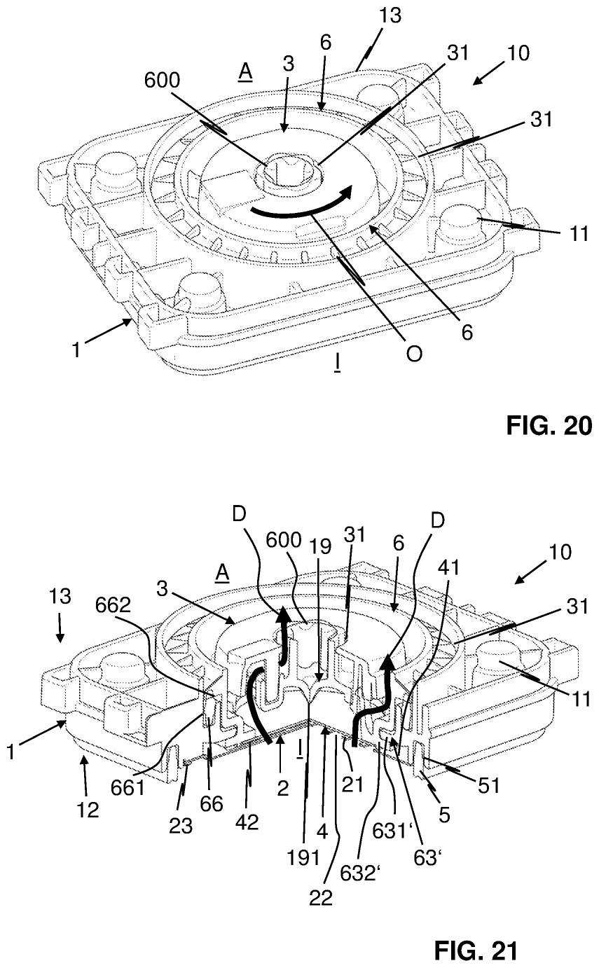

In FIG. 20 to FIG. 24, finally a fifth embodiment of the degassing unit 10 according to the invention is illustrated which differs in many aspects from the other embodiments described herein.

First, the membrane carrier 6 is connected from an outer side 13 of the main body 1 to the main body 1 so that the membrane carrier 6 in situ, i.e., while the main body 1 is mounted at a battery housing, can be exchanged, which is indicated in FIG. 20. In this context, the membrane carrier 6 is connected by a bayonet connection 63′ (see FIG. 21) to the main body 1. In FIG. 20, the membrane carrier 6 is illustrated in a state connected to the main body 1; in order to separate it from the main body 1, for example, in order to exchange a defective membrane 4, the membrane carrier 6 is first rotated in a first movement phase in relation to the main body 1 in an opening rotation direction O which is counterclockwise or extends in the mathematical positive rotation direction in the example. In a second movement phase, the membrane carrier 6 can be removed in axial direction.

In order to facilitate rotation and to introduce, as needed, a significant release torque, the membrane carrier 6 comprises a tool engagement region 600 in which a hexalobe socket and/or hexalobe head is present. In embodiments, not illustrated, the tool engagement region 600 can however also be any other contour suitable to a person of skill in the art for introducing a torque. In particular, it is also possible that the tool engagement region 600 has a proprietary engagement contour which cannot be actuated with standard tools.

The degassing unit comprises two spatially separated regions of venting openings 31. A first region with venting openings 31 is present in an annular space between the tool engagement region 600 and the cover 3.

The cover 3 has a central cutout through which the tool engagement region 600 of the membrane carrier 6 projects.

A second region with venting openings 31 is positioned in an annular space between the cover 3 and the membrane carrier 6.

In other words, the first region with venting openings 31 can be a radially inwardly positioned region and the second region with venting openings 31 can be a radially outwardly positioned region.

In the isometric partial section view of FIG. 21, the degassing fluid paths D which lead to the venting openings 31 as well as the bayonet connection 63′ can be seen.

The bayonet connection 63′ comprises first bayonet connection means 631′ at the main body 1 and second bayonet connection means 632′ at the membrane carrier 6 which together form the bayonet connection 63′. In the blocked state illustrated in FIG. 21, the second bayonet connection means 632′ of the membrane carrier 6 engage behind the first bayonet connection means 631′ of the main body 1, whereby an axial degree of freedom of movement of the membrane carrier 6 in relation to the main body 1 is blocked.

The cover 3 is connected to the membrane carrier 6 by a plurality of snap connections arranged distributed about the circumference.

The membrane carrier 6 is fluid-tightly sealed circumferentially around the gas passage opening in relation to the main body 1, wherein an axially acting seal element 66 is provided which is received in a corresponding seal groove 661 of the main body 1. A groove base of the seal groove 661 provides a first circumferentially extending contact surface for the seal 66 while a radially projecting collar 662 of the membrane carrier 6 provides a second circumferentially extending seal surface for the seal 66.

The seal pretension force which is acting in axial direction is generated by the bayonet connection 63′.

The membrane 4 is again spanned at the inner side by a fluid-permeable membrane support device 2 which is present at a predetermined distance away from the membrane 4. The membrane support device 2 has a plurality of grid webs 21 between which a plurality of grid openings 22 are present. The membrane support device 2 is embodied in particular as a metal component and is connected directly to the main body 1, namely at the main body inner side 12. The connection of the membrane support device 2 and the main body 1 is realized by rivet connections 23 which can be produced in the plastic material of the main body 1 particularly easily and reliably.

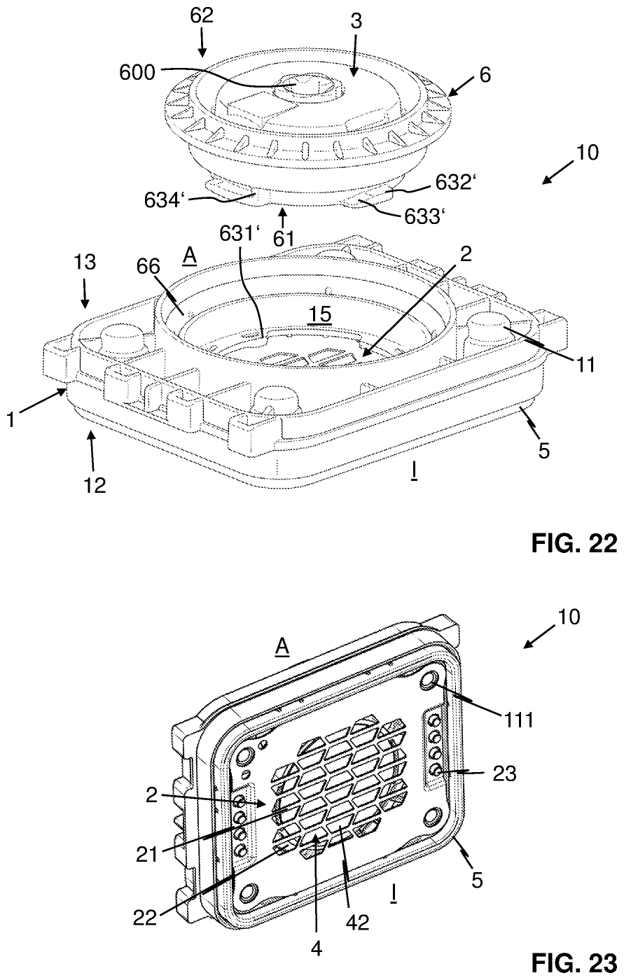

With reference to FIG. 22, the fifth embodiment of the degassing unit 10 according to the invention is described further. In this context, the membrane carrier 6 is illustrated in a state separated from the main body 1, wherein the bayonet connection 63′ is in its released state. The seal 66 which seals the membrane carrier 6 in the mounted state circumferentially in relation to the main body 1 is arranged in its seal groove adjacent to the gas passage opening 15.

At the membrane carrier 6, a plurality of second bayonet connection means 632′ is formed while at the main body 1 a plurality of first bayonet connection means 631′ is formed. In order to couple the membrane carrier 6 to the main body 1, the membrane carrier 6 is inserted in a first movement phase in axial direction into the gas passage opening 15, wherein the second bayonet connection means 632′ of the membrane carrier 6 plunge through intermediate spaces between the first bayonet connection means 631′ of the main body 1. In a second movement phase, the membrane carrier 6 is then rotated in clockwise direction or in the mathematically negative rotational direction in relation to the main body 1, whereby the bayonet connection 63′ is blocked.

The first and second bayonet connection means 631′, 632′ each comprise a securing wall which extends in a circumferential direction and which extends substantially in a plane which is parallel to the membrane 4 and/or membrane support device 2. Due to the afore described rotation of the membrane carrier 6, it is achieved that the securing walls of the second bayonet connection means 632′ of the membrane carrier 6 are displaced behind the securing walls of the first bayonet connection means 631′ of the main body, which effects the form fit blockage in axial direction.

At least one of the second bayonet connection means 632′ of the membrane carrier 6 comprises a rotation angle stop 634′ which predetermines an intended rotation angle end position of the membrane carrier 6. The rotation angle stop 634′ is embodied in the form of a blocking wall which adjoins the securing wall of at least one of the second bayonet connection means 632′ and which extends in axial direction or at an acute angle to the axial direction.

Furthermore, the second bayonet connection means 632′ of the membrane carrier 6 comprise at least one ramp section 633′ extending in circumferential direction which is configured to convert a relative rotation movement of the membrane carrier 6 in relation to the main body 1 into an axially oriented contact force. The ramp section 633′ makes it possible to pretension the axially acting seal 66 between membrane carrier 6 and main body 1 by rotation of the membrane carrier 6.

At least one of the second bayonet connection means 632′ of the membrane carrier 6 comprises a rotation angle stop 634′. Preferably, two in particular circumferentially oppositely positioned second bayonet connection means 632′ comprise a rotation angle stop 634′ while two further second bayonet connection means 632′ each comprise a ramp section 633′.

FIG. 23 shows the degassing unit 10 according to the invention according to the fifth embodiment in an isometric view from the inner side I. The function and fastening of the fluid-permeable membrane support device 2 corresponds substantially to the herein afore described fourth embodiment.

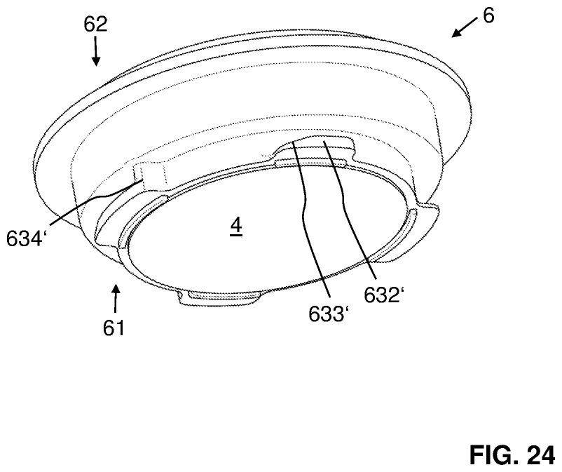

In FIG. 24, the membrane carrier 6 of the degassing unit 10 according to the invention is illustrated by itself in an isometric view. It can be seen that, distributed about the circumference, four second bayonet connection means 632′ are present which in particular are spaced apart from each other by uniform angle distances. At its inner side 61, the membrane carrier 6 carries the membrane 4 which is connected circumferentially fluid-tightly to the membrane carrier 6 by material fusion, in particular welded, glued or molded around by the material of the membrane carrier 6.

1. A degassing unit for a battery housing, the degassing unit comprising:
a main body comprising:
at least one fastening means action region configured to attach the degassing unit fluid-tightly to a rim of a pressure compensation opening of the battery housing; and
a gas passage opening;
a membrane configured to cover the gas passage opening;
a fluid-permeable membrane support device spanned across the membrane at an inner side of the membrane; and
a membrane carrier separate from the main body and configured to be connected by a reversibly detachable fastening device to the main body such that a relative mobility of the membrane carrier and the main body relative to each other is blocked in an axial direction,
wherein the membrane is fastened by material fusion to the membrane carrier, and
wherein the membrane carrier is configured to be sealed around the gas passage opening circumferentially and fluid-tightly in relation to the main body.

2. The degassing unit according to claim 1, wherein the reversibly detachable fastening device comprises one among a bayonet connection, a snap connection, and a holding element.

3. The degassing unit according to claim 1, wherein the reversibly detachable fastening device is a bayonet connection, and
wherein the membrane carrier is configured to rotate in relation to the main body, and to transfer the bayonet connection from a blocked state into a released state, and vice versa.

4. The degassing unit according to claim 3, wherein an outer side of the membrane carrier comprises a tool engagement region configured to introduce a torque.

5. The degassing unit according to claim 3, wherein the main body comprises first bayonet connection means,
wherein the membrane carrier comprises second bayonet connection means, and
wherein the first bayonet connection means and the second bayonet connection means together form the bayonet connection.

6. The degassing unit according to claim 5, wherein the first bayonet connection means and/or the second bayonet connection means comprise a rotation angle stop predetermining an intended rotation angle end position of the membrane carrier.

7. The degassing unit according to claim 5, wherein the first bayonet connection means and/or the second bayonet connection means comprise at least one ramp section extending in a circumferential direction of the bayonet connection, and
wherein the at least one ramp section is configured to convert a relative rotation movement of the membrane carrier in relation to the main body into an axially oriented contact force.

8. The degassing unit according to claim 1, wherein the membrane support device is a component separate from the membrane carrier, and
wherein the membrane support device is arranged at an inner side of the main body.

9. The degassing unit according to claim 8, wherein the membrane support device is connected immediately to the main body at the inner side of the main body.

10. The degassing unit according to claim 9, wherein the membrane support device is the reversibly detachable fastening device and acts as a holding element holding the membrane carrier with form fit at the main body.

11. The degassing unit according to claim 1, wherein the membrane support device is formed monolithically with the membrane carrier.

12. The degassing unit according to claim 1, wherein the membrane carrier comprises a fluid-permeable gas passage region and a membrane fastening region circumferentially surrounding the gas passage region,
wherein the membrane is connected circumferentially to the membrane carrier in the membrane fastening region, and
wherein the membrane completely covers the gas passage region.

13. The degassing unit according to claim 1, wherein the membrane is a semipermeable membrane configured to permit passage of gaseous media from an environment into the battery housing and in reverse, and to prevent passage of liquid media and/or solids.

14. The degassing unit according to claim 1, wherein the membrane carrier has a round cross section or a polygonal cross section.

15. The degassing unit according to claim 1, wherein the membrane carrier is sealed by a circumferentially extending seal element in relation to the main body, and
wherein the circumferentially extending seal element is an O-ring seal or a seal lip.

16. The degassing unit according to claim 15, wherein the circumferentially extending seal element is a radially and/or axially acting seal element.

17. The degassing unit according to claim 1, wherein the membrane carrier is connected from an outer side of the degassing unit to the main body, and
wherein the membrane carrier is arranged at an outer side of the main body.

18. The degassing unit according to claim 1, wherein the membrane carrier is connected from an inner side of the degassing unit to the main body, and
wherein the membrane carrier is arranged at an inner side of the main body.

19. The degassing unit according to claim 1, further comprising a cover comprising at least one venting opening,
wherein the cover is connected externally to the main body and/or to the membrane carrier.

20. A battery housing configured to receive battery cells, the battery housing comprising:
at least one housing wall with a pressure compensation opening; and
a degassing unit comprising:
a main body comprising:
at least one fastening means action region configured to attach the degassing unit fluid-tightly to a rim of the pressure compensation opening; and
a gas passage opening;
a membrane configured to cover the gas passage opening;
a fluid-permeable membrane support device spanned across the membrane at an inner side of the membrane; and
a membrane carrier separate from the main body and configured to be connected by a reversibly detachable fastening device to the main body such that a relative mobility of the membrane carrier and the main body relative to each other is blocked in an axial direction,
wherein the membrane is fastened by material fusion to the membrane carrier, and
wherein the membrane carrier is configured to be sealed around the gas passage opening circumferentially and fluid-tightly in relation to the main body.
